(19) United States
(12) Patent Application Publication
(10) Pub. No.: US 2015/0095248 A1
(43) Pub. Date: Apr. 2, 2015

(54) Method for requesting and sharing purchases, recommendations, and reviews

(71) Applicants: Jennie Wong, Sunnyvale, CA (US); Stephen Andrew Krause, Sunnyvale, CA (US)

(72) Inventors: Jennie Wong, Sunnyvale, CA (US); Stephen Andrew Krause, Sunnyvale, CA (US)

(21) Appl. No.: 14/039,750

(22) Filed: Sep. 27, 2013

(51) Int. Cl. G06Q 50/00; G06Q 30/06

(52) U.S. Cl. CPC G06Q 50/01; G06Q 30/0601
USPC 705/319

(57) ABSTRACT

Method for requesting and sharing purchases, recommendations, and reviews. Initial user input may be received requesting purchases, recommendations, or reviews and specifying one or more friends and/or family and/or their contact information. A message containing the request may be automatically created and transmitted. User input responding to said request may be received. A message containing the response may be automatically created and transmitted to the requester. Additionally, or alternatively, initial user input may be received specifying a purchase, recommendation, or review to be shared and specifying one or more friends and/or family and/or their contact information. A message containing the user input may be automatically created and transmitted. In one embodiment, said messages may be transmitted via email or social network, saved to user accounts, and accessed via the internet.

### CROSS REFERENCE TO RELATED APPLICATIONS

This application claims the benefit of PPA Ser. No. 61/744,832, filed Oct. 4, 2012 by the present inventors, which is incorporated by reference.

### BACKGROUND

The present invention relates to the fields of ecommerce, social media, social commerce, and online opinions, and more particularly to a method for requesting and sharing purchases, recommendations, and reviews.

In recent years, products available for sale, ecommerce websites, and online opinions have proliferated. It is common for shoppers to spend time looking at products available for sale both online and offline, and reading product descriptions and online opinions.

Many shoppers desire a way to efficiently research and decide what they will buy. Currently, shoppers may use physical retail and secondhand stores, ecommerce websites, and online opinions. However, shoppers may wish to use a method for requesting and sharing purchases, recommendations, and reviews from and with friends and/or family.

Accordingly, using present solutions, shoppers may use email or social media to request and share purchases, recommendations, and reviews from and with friends and/or family. These solutions lack functionality specific to requesting and sharing purchases, recommendations, and reviews, and saving and accessing said requests and shared information for later use.

Accordingly, improvements in requesting and sharing purchases, recommendations, and reviews are desired.

### SUMMARY OF THE INVENTION

Various embodiments of a method for requesting and sharing purchases, recommendations, and reviews are presented below.

Initially, a user may provide user input of a request for a purchase, recommendation, or review. The user may then provide user input of names and contact information for friends and/or family. In response to the user input, a message may be automatically created and transmitted on behalf of the user to the contact information provided. In some embodiments, the message may be transmitted via email or social media. In one embodiment, the contact information is saved to the user's account information as a group.

Once the message is created and transmitted, recipients may respond to the request with user input regarding a purchase, recommendation, or review. For example, a recipient may share the uniform resource locator for an ecommerce product page or a service company website, or text of a personal opinion. In one embodiment, users may elect to display their input to other users.

Once the recipient provides their user input, a message may be automatically created and transmitted to the original user who provided the request. In some embodiments, the message may be transmitted via email or social media. Alternatively, or additionally, the user input may be saved to user accounts of the original user who provided the request and/or the recipient user who responded to the request.

Alternatively, or additionally, a user may initially provide user input of a purchase, recommendation, or review to be shared. The user may then provide user input of names and/or contact information for friends and/or family. In response to the user input, a message may be automatically created and transmitted on behalf of the user to the contact information provided. In some embodiments, the message may be transmitted via email or social media. In one embodiment, the contact information is saved to the user's account information as a group. In some embodiments, recipients may comment on the user input.

Alternatively, or additionally, user input may be saved to user accounts. In one embodiment, saved user input may be accessed by the internet or other network.

A variety of mechanisms may be used for providing user input, including but not limited to mail, networked computer, mobile or wearable or biological internet-enabled device, email, website, web or mobile or wearable or biological application.

### DESCRIPTION OF DRAWINGS

The present invention may be understood by consideration of the following description of one embodiment and related drawings, in which:

FIG. 1 illustrates a network system comprising two or more computer systems configured according to one embodiment;

FIG. 2 is a flowchart diagram illustrating one embodiment of a method for requesting purchases, recommendations, and reviews.

FIG. 3 is a flowchart diagram illustrating one embodiment of a method for sharing purchases, recommendations, and reviews in response to a request.

FIG. 4 is a flowchart diagram illustrating one embodiment of a method for sharing purchases, recommendations, and reviews.

### DESCRIPTION OF THE INVENTION

### Terms

“Computer system” is defined as any of various types of computing or processing systems, including mainframes, workstations, personal computers, network appliance, internet appliance, personal digital assistant, television system, grid computing system, tablet device, smartphone, wearable computer, biological computer, or other device or combination of devices. In general, the term “computer system” can be defined to encompass any device or combination of devices having at least one processor.

“Joining” a question is defined as permitting your user input to be displayed to other users who have made the same selection for that question.

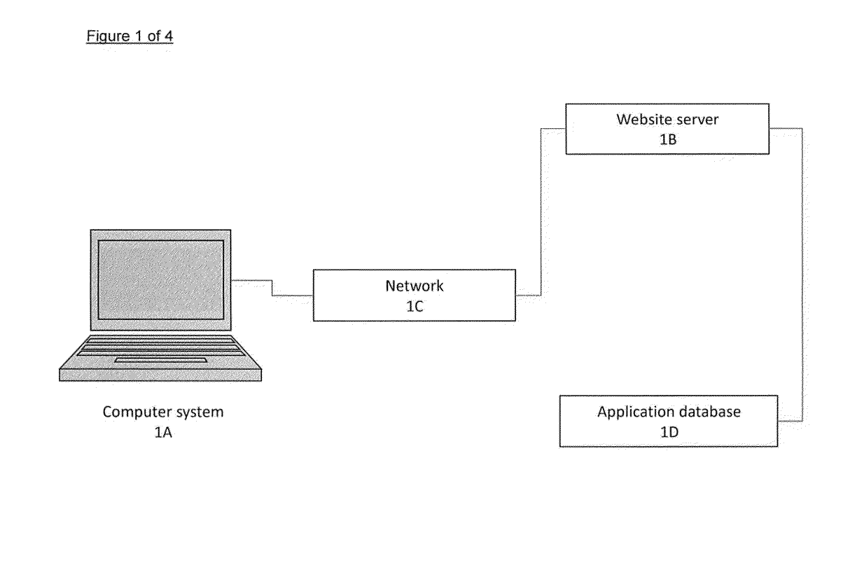

### FIG. 1

### Exemplary Network

FIG. 1 illustrates a system including a computer system 1A that is connected to a website server 1B via a network 1C, where the website server is also connected to an application database 1D. In one embodiment, a user may use the computer system 1A to interact with the website server 1B and the application database 1D via the network 1C, as described herein.

The computer system 1A may include any of various input devices, e.g. a keyboard and mouse, and any of various display devices, e.g. a color monitor, capable of displaying a graphical user interface or website hosted on website server 1B.

The website server 1B may include any combination of hardware and software capable of delivering any text or graphical content to any computer system via any network.

The network 1C may be any of various types, including, but not limited to, local area network, wide area network, the internet, or an intranet, among others. The network 1C may also be a combination of any various types of networks.

The application database 1D may include any combination of hardware and software capable of receiving, storing, and providing data from and to one or more applications or user interfaces.

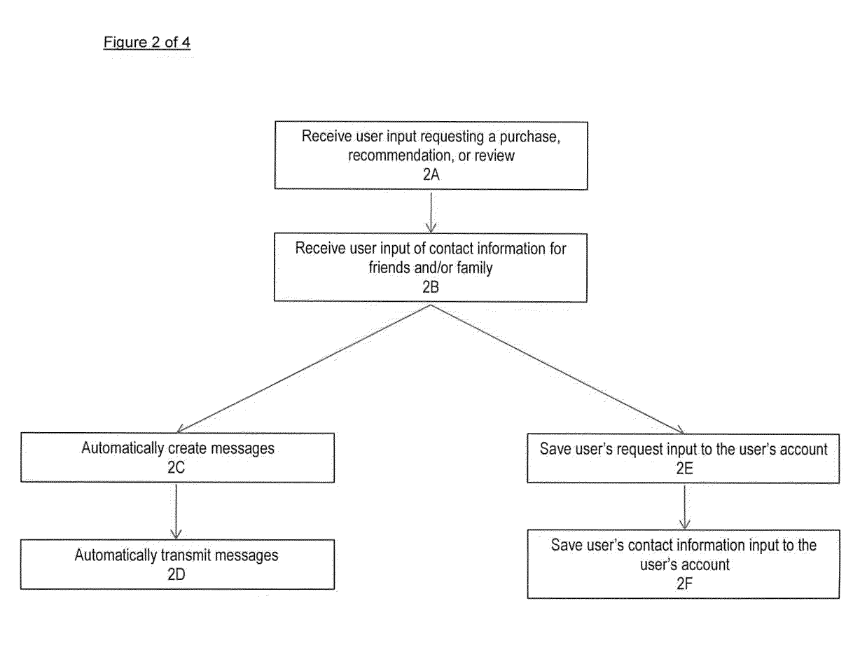

### FIG. 2

### Requesting a Purchase, Recommendation, or Review

FIG. 2 illustrates a method for requesting a purchase, recommendation, or review. The method shown in FIG. 2 may be used in conjunction with any of the computer systems or devices or combination of the devices named above, among other devices. In various embodiments, some of the method elements shown may be performed concurrently, in various alternative orders, or may be omitted. Additional method elements may be performed. As shown, this method may operate as follows.

Initially, in 2A, user input requesting a purchase, recommendation, or review may be received. In one embodiment, a user may use computer system 1A to specify a desired recommendation, e.g. for soccer shoes.

In 2B, user input of contact information for friends and/or family may be received. In one embodiment, the user may use computer system 1A to specify one or more desired friends and/or family and/or their contact information, e.g. Jane Doe with the email address of JaneDoe@gmail.com. Additionally or alternatively, the user may specify one or more friends and/or family by selecting one or more previously saved groups.

In 2C and 2D, one or more messages may be automatically created and transmitted. In one embodiment, the message may be transmitted via network 1C. For example, the message requesting a recommendation for “soccer shoes” may be created as an email and transmitted via the internet to Jane Doe at the email address of JaneDoe@gmail.com.

In 2E and 2F, user's request input and contact information input may be saved to the user's account. In one embodiment, the user's request input and contact information input may be saved to the user's account on application database 1D. Additionally or alternatively, the user's input of contact information for one or more friends and/or family may be saved as a group, either with a system generated group name or user specified group name.

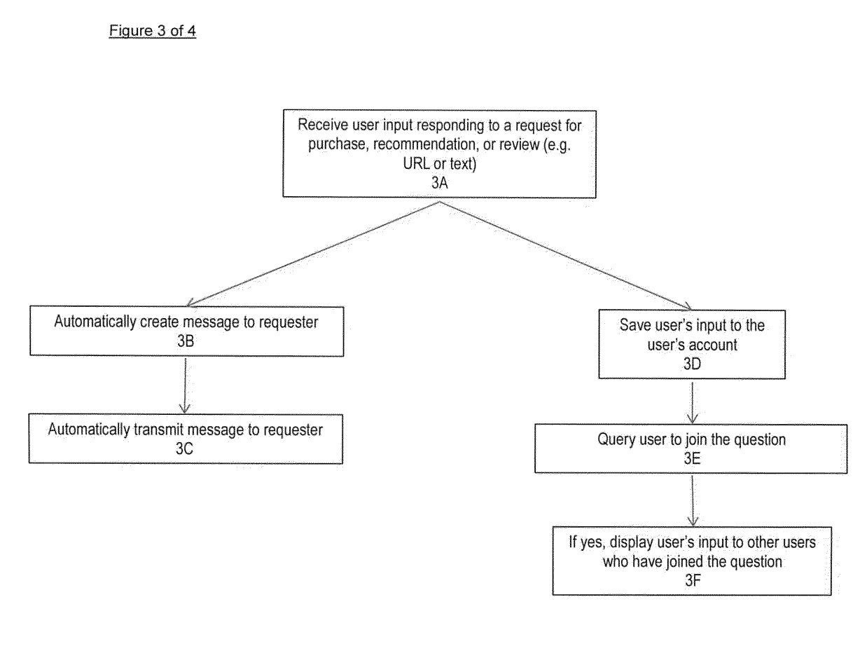

### FIG. 3

### Sharing a Purchase, Recommendation or Review in Response to a Request

FIG. 3 illustrates a method for sharing a purchase, recommendation, or review in response to a request. The method shown in FIG. 3 may be used in conjunction with any of the computer systems or devices or combination of the devices named above, among other devices. In various embodiments, some of the method elements shown may be performed concurrently. In various alternative orders, or may be omitted. Additional method elements may be performed. As shown, this method may operate as follows.

In 3A, user input of a purchase, recommendation, or review in response to a request may be received, In one embodiment, in response to a request for a purchase, recommendation, or review, a user may use computer system 1A to specify a purchase using a uniform record locator and a review using text, e.g. http//store.nike.com/us/en_us/product/tiempo-legend-4-id-junior/?piid=32739&pbid=1094747975#?pbid=1094747975, and “My kid loves these Nike Tiempo Legend soccer shoes.”

In 3B and 3C, one or more messages may be automatically created and transmitted. In one embodiment, the message may be transmitted via network 1C. For example, the user's purchase and review input may be created as an email and transmitted via the internet to the requester.

In 3D, the user's input of the purchase, recommendation, or review in response to a request may be saved to the user's, account. In one embodiment, the user's input of the purchase, recommendation, or review in response to a request may be saved to the user's account on application database 1D.

In 3E, the user may be queried regarding joining the question. If the user input is “yes,” in 3F the user input sharing a purchase, recommendation, or review may be displayed to other users who have joined the question. In one embodiment, the user's joining decision may be saved to the user's account on application database 1D.

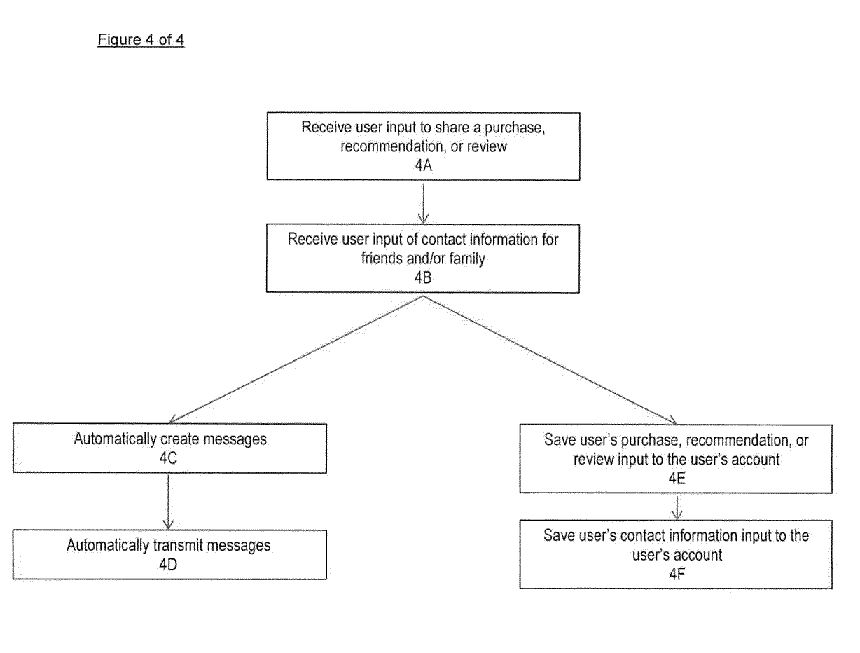

### FIG. 4

### Sharing a Purchase, Recommendation, or Review

FIG. 4 illustrates a method for sharing a purchase, recommendation, or review. The method shown in FIG. 4 may be used in conjunction with any of the computer systems or devices or combination of the devices named above, among other devices. In various embodiments, some of the method elements shown may be performed concurrently, in various alternative orders, or may be omitted. Additional method elements may be performed, As shown, this method may operate as follows.

Initially, in 4A, user input sharing a purchase, recommendation, or review may be received. In one embodiment, a user may use computer system 1A to specify a purchase, recommendation, or review, e.g. specifying a purchase by using a uniform resource locator such as http//store.nike.com/us/en_us/product/tiempo-legend-4-id-junior/?piid=32739&pbid=1094747975#?pbid=1094747975 and specifying a review by inputting text such as, “Everyone should check out these Nike Tiempo Legend soccer shoes.”

In 4B, user input of contact information for friends and/or family may be received. In one embodiment, the user may use computer system 1A to specify one or more desired friends and/or family and/or their contact information, e.g. Jane Doe with the email address of JaneDoe@gmail.com. Additionally or alternatively, the user may specify one or more friends and/or family by selecting one or more previously saved groups.

In 4C and 4D, one or more messages may be automatically created and transmitted. In one embodiment, the message may be transmitted via network 1 C. For example, the message sharing purchase uniform resource locator http//store.nike.com/us/en_us/product/tiempo-legend-4-id-junior/?piid=32739&pbid=1094747975#?pbid=1094747975 and text review “Everyone should check out these Nike Tiempo Legend soccer shoes,” may be created as an email and transmitted via the internet to Jane Doe at the email address of JaneDoe@gmail.com.

In 4E and 4F, user's shared purchase, recommendation, or review input and contact information input may be saved to the user's account. In one embodiment, the user's request input and contact information input may be saved to the user's account on application database 1D. Additionally or alternatively, the user's input of contact information for one or more friends and/or family may be saved as a group, either with a system generated group name or user specified group name.

### Additional Embodiments

Additional embodiments and implementations of the invention are envisioned.

One such additional embodiment replaces the computer system 1A with input received as hardcopy where network 1C is a public or private delivery network, e.g. a letter delivered by U.S. mail.

Another such additional embodiment replaces the computer system 1A with input received as sound waves, where network 1C is a communication network, e.g. a phone call made by cellular network.

Although the embodiments above have been described in detail, numerous variations and modifications will become apparent to those skilled in the art upon thorough reading of the disclosure. The following claims are intended to embrace all such variations and modifications.

We claim:

1. A method for requesting and sharing purchases, recommendations, and reviews, comprising:
a computer server receiving user input from a user requesting or sharing a purchase, recommendation, or review, wherein the user input is provided via the internet or other network;
a computer server receiving user input from the user specifying one or more friends and/or family and/or their contact information, wherein the user input is provided via the internet or other network;
a computer server automatically creating and transmitting the user's input requesting or sharing a purchase, recommendation, or review as a message to one or more specified friends and/or family, wherein the message is transmitted via any type of network or combination of networks,
whereby the user may request or share purchases, recommendations, and reviews from or with desired friends and/or family.

2. The method of claim 1, wherein the user input sharing a purchase, recommendation, or review is in response to a request.

3. The method of claim 1, wherein the user input specifying one or more friends and/or family is selected from one or more previously saved groups.

4. The method of claim 1, wherein user input is saved to user accounts.

5. The method of claim 4, wherein saved user input may be accessed by the internet or other network.
